(19) United States
(12) Patent Application Publication
(10) Pub. No.: US 2026/0072436 A1
(43) Pub. Date: Mar. 12, 2026

(54) SEMANTIC-BASED ROBOTIC NAVIGATION AND MANIPULATION IN COMPLEX ENVIRONMENTS

(71) Applicant: Field AI, Inc., Mission Viejo, CA (US)

(72) Inventors: Dong Ki KIM, Cambridge, MA (US); Shayegan OMIDSHAFIEI, Dorchester, MA (US); Yafei HU, Charlestown, MA (US); Amirreza SHABAN, Seattle, WA (US)

(73) Assignee: Field AI, Inc., Mission Viejo, CA (US)

(21) Appl. No.: 19/327,376

(22) Filed: Sep. 12, 2025

Related U.S. Application Data
(60) Provisional application No. 63/693,826, filed on Sep. 12, 2024.

(51) Int. Cl. G05D 1/246; G05D 1/648; G05D 111/10; G05D 111/63

(52) U.S. Cl. CPC G05D 1/2467; G05D 1/648; G05D 2111/10; G05D 2111/65

(57) ABSTRACT

A method of and system for navigation and manipulation for a robot can include obtaining, by at least one camera and at least one depth sensor, a first visual data set and translating the first visual data set into a continuous three-dimensional map. The three-dimensional map can include semantic information and geometric information. The method and system may further include receiving instruction data and converting the instruction data into at least one task for the robot within the continuous three-dimensional map.

### CROSS-REFERENCE TO RELATED APPLICATION

This application claims priority to and the benefit of the filing date of provisional U.S. Patent Application No. 63/693,826, entitled “SYSTEM AND METHOD FOR SEMANTIC-BASED ROBOTIC NAVIGATION IN COMPLEX ENVIRONMENTS” and filed on Sep. 12, 5044, the entire contents of which is hereby expressly incorporated herein by reference.

### TECHNICAL FIELD

The embodiments of the present disclosure relate to robotic navigation and manipulation, and specifically to systems and methods for robotic navigation that can utilize semantic and geometric information in a single three-dimensional map.

### BACKGROUND

Three-dimensional (3D) exploration and navigation systems have become increasingly important in various fields, including robotics, virtual reality, and autonomous vehicles. The three-dimensional exploration and navigation systems aim to enable efficient and effective exploration of complex three-dimensional environments, allowing one or more robots to navigate and interact with their surroundings. However, traditional approaches to three-dimensional exploration rely on geometric representations of environments, which may lack semantic understanding and context.

The ability to perceive and interpret the semantic understanding of a three-dimensional scene can be important for intelligent exploration and decision-making. Semantic information may provide valuable cues about nature, function, and relationships of objects within the environment. Incorporating semantic information into the three-dimensional exploration and navigation systems has the potential to significantly enhance their capabilities and efficiency.

Recent advancements in computer vision and machine learning have led to improved techniques for extracting semantic information from visual data. However, integrating semantic understanding into a continuous and efficient representation of a three-dimensional space remains a challenge. Many existing approaches struggle to balance the richness of semantic information with computational efficiency required for real-time exploration and navigation.

Furthermore, current exploration strategies rely on random or predefined patterns, which may not effectively leverage semantic structure of the environment. This may result in suboptimal exploration paths and inefficient use of resources, particularly in complex environments.

As the demand for more intelligent and context-aware three-dimensional exploration and navigation systems continues to grow, there is a need for innovative approaches that may seamlessly integrate semantic understanding with efficient spatial representations and exploration strategies. Such advancements may have far-reaching implications across various domains, from improving autonomy of robotic systems to enhancing user experiences in virtual environments.

### SUMMARY

In one general aspect, the instant disclosure describes a system having a processor and a memory in communication with the processor, where the memory includes executable instructions that, when executed by the processor, cause the system to perform multiple functions. These functions may include obtaining, by at least one camera and at least one depth sensor, a first visual data set, and translating the first visual data set into a continuous three-dimensional map. The three-dimensional map can include semantic information and geometric information. The functions may further include receiving instruction data and converting the instruction data into at least one task for the robot within the continuous three-dimensional map.

In another general aspect, the instant disclosure describes a method of navigation for a robot. This method of navigation may involve multiple steps. These steps may include obtaining, by at least one camera and at least one depth sensor, a first visual data set, and translating the first visual data set into a continuous three-dimensional map. The three-dimensional map can include semantic information and geometric information. The steps may further include receiving instruction data and converting the instruction data into at least one task for the robot within the continuous three-dimensional map.

In yet another general aspect, the instant disclosure describes a non-transitory computer readable medium on which are stored instructions that when executed cause a programmable device to perform multiple functions. These functions may include obtaining, by at least one camera and at least one depth sensor, a first visual data set, and translating the first visual data set into a continuous three-dimensional map. The three-dimensional map can include semantic information and geometric information. The functions may further include receiving instruction data and converting the instruction data into at least one task for the robot within the continuous three-dimensional map.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a flow diagram illustrating an example method for robot navigation.

FIG. 2 is a flow diagram illustrating an example method for translating the first visual data set into a continuous three-dimensional map.

FIG. 3 is a flow diagram illustrating an example method for robot navigation.

FIG. 4 is a flow diagram illustrating an example method for converting the instruction data into at least one task for the robot.

FIG. 5 depicts an example environment in which the system of the present embodiments may operate.

FIG. 6 is a block diagram showing an example system of the present embodiments along with its corresponding subsystems.

FIG. 7 is a block diagram showing an example data processing subsystem of the system shown in FIG. 6.

FIG. 8 is a block diagram showing an example navigation subsystem of the system shown in FIG. 6.

FIG. 9 depicts an example data flow to and within the system of the present embodiments.

FIG. 10 is a block diagram showing an example software architecture, various portions of which may be used in conjunction with various hardware architectures herein described, which may implement any of the described features.

FIG. 11 is a block diagram showing components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well-known methods, procedures, components, and/or circuitry have been described at a relatively high-level, without detail, in order to avoid unnecessarily obscuring aspects of the present teachings.

### Technical Problem

Efficient representation of continuous three-dimensional scenes can be important to computer vision, graphics, and mixed reality, and therefore, to robot navigation using these technologies. This representation of continuity can be achieved by explicit geometric continuity, which can include meshes, volumetric continuity, which can include voxel grids or voxel fields, or point-based continuity. Methods can include Neural Radiance Fields (NeRFs), of which Vision-Language Frontier Models (VLFMs) are a subset. However, these methods can be computationally expensive, as they rely upon secondary frameworks and files for object recognition and semantic labeling. Further, as the results are nondifferentiable, this object recognition can be more difficult, as the semantic information is not explicit without use of a secondary framework, object recognition may need to be repeatedly inferred after rendering an individual scene because NeRFs inherently rely upon techniques such as sampling, interpolation, and ray-marching to simulate continuity based on what remains a map consisting of inherently discrete data.

### Technical Solution

In contrast, three-dimensional Gaussian splatting (3DGS) has the unique capability to provide not just a representation of continuity, but continuous, explicit, and real-time rendering of three-dimensional scenes that NeRFs and VLFMs lack due to inherently operating in discrete spaces lacking true spatial continuity. 3DGS can be used to encode both geometric information and semantic information within a single, continuous three-dimensional map used for robot navigation. As used herein, “geometric information” refers to the properties of at least one object within a three-dimensional map related to at least position, shape, and size of the object. As used herein, “continuous three-dimensional map” shall mean “a three-dimensional map where each object within the map is explicitly defined by a continuous function” or “a three-dimensional map where each object within the map is defined by a continuous function at any arbitrary point, without the need for sampling or interpolation.” As used herein, “semantic information” shall mean information related to what the objects are and information pertaining to their relationships to other objects, not just where they are. As described above, this can be a map that is effectively a dense cloud of three-dimensional Gaussian ellipsoids, where each ellipsoid is defined by a spatial position, size, and shape. This ellipsoid can be further defined by covariance, which can be defined by a 3×3 matrix. The ellipsoids can include information about color, opacity, and other view-dependent properties. This representation can produce not just a photo-realistic rendering, but a platform for encoding both geometric and semantic information simultaneously.

Each three-dimensional Gaussian can inherently include geometric properties of the scene. Regarding position, the center of a Gaussian corresponds to a real three-dimensional location within the scene. The addition of further Gaussian ellipsoids distributed across surfaces within the map can collectively represent the shape and contours of objects. A covariance matrix can be used to define an anisotropic spread of an ellipsoid, which can be information about elongation within different directions of the map. This allows the encoding of fine surface detail and local geometry, such as the curvature of a coffee mug's handle or the flatness of a tabletop. Areas with more concentrated Gaussians imply sharp features, such as edges or object boundaries, while smoother surfaces may be covered by fewer, broader Gaussians. The depth of objects can be naturally handled via perspective projection and occlusion in the splatting process. Since splatting is rendered from the Gaussians' three-dimensional positions, observers can freely move around the scene and perceive depth, orientation, and spatial relationships, thereby making it a true geometric representation and enabling real-time rendering. The structure of the cloud of Gaussian ellipsoids serves as a direct, explicit encoding of a scene's geometry, and thereby provides a continuous three-dimensional map with geometric information.

Further, 3DGS can encode semantic information. This can be achieved using color coding. Thereby, 3DGS can produce a continuous, three-dimensional map with embedded geometric information and semantic information within the same structure. There is no need for separate geometry and label files, or separate maps that include semantic information and geometric information separately. A single Gaussian cloud can drive photorealistic rendering, geometric queries, such as collision detection, and semantic understanding, such as object identification.

### Advantages of the Technical Solution

3DGS can include a dense, spatially continuous representation of geometry and appearance. 3DGS can provide an explicit, continuous representation by using a collection of ellipsoidal objects defined at least by position and covariance, which can include orientation, and have a non-zero spatial extent. These ellipsoids can further be defined by radiometric properties such as color, alpha, and shading, and by view-dependent features such as specularity or anisotropy. These objects can be projected and blended in an image space using a forward rendering pipeline, as opposed to the ray-marching techniques of NeRFs. Therefore, each Gaussian object can blur into nearby space, and is not a hard, discrete point, but a smooth function in three-dimensional space that can overlap with neighboring objects, thereby generating a continuous volumetric field constructed from discrete elements. Due to the density and overlap of the Gaussian ellipsoids, there is no need for regular sampling or interpolation between discrete objects to represent a three-dimensional space; the entire three-dimensional space is defined in a continuous manner, and any two-dimensional projection, such as a camera view, will result in a smooth image due to the blending of the ellipsoids. Therefore, 3DGS can provide high-fidelity renderings at any arbitrary viewpoint within the three-dimensional map, thereby creating a continuous map in both geometry and appearance. Further, 3DGS can provide a three-dimensional map that is both differentiable and explicitly parameterized in that each Gaussian can be updated independently to improve fidelity, add semantic information, or support real-time editing. Thereby, by providing a continuous three-dimensional map for robot navigation, the current embodiments can provide methods and systems for robot navigation that offer substantial improvements over discrete representation methods.

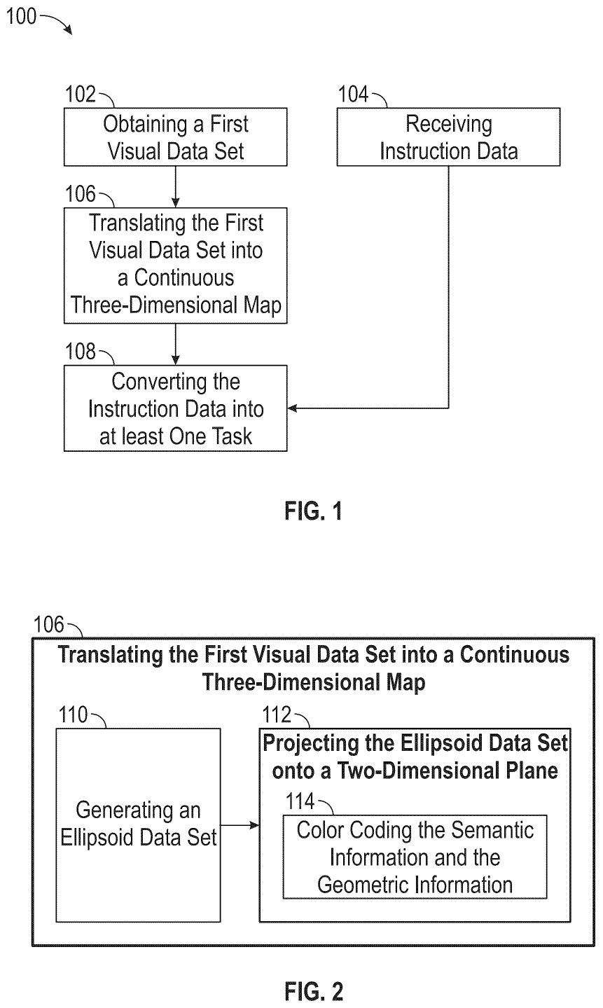

FIG. 1 is a flow diagram illustrating an example method 100 for robot navigation. The method 100 for robot navigation can include obtaining a first visual data set (Step 102). The first visual data set may be obtained by at least one camera and at least one depth sensor. The first visual data set may include visual odometry data, red-green-blue (RGB) data, red-green-blue-depth (RGBD) data, and combinations thereof. The first visual data set can include data obtained directly from a camera and depth sensor or previously obtained by camera or depth sensor and stored in a database or memory unit and communicated by a communications network to a system.

The first visual data set can include or consist of inherently discrete data. The inherently discrete data may include sensor measurements, from a camera or plurality of camera and a depth sensor or plurality of depth sensors, a set of points in three dimensional space x₁, x₂, x₃, . . . xₙ∈ [symbol] . Stored as pure points, they can be expressed as a sum of Dirac delta functions f(x)=Σδ(x−xᵢ) where δ(x−xᵢ)=1 if x=xᵢ and 0 otherwise. This representation is inherently discrete; it is zero everywhere except at the measured points. It is not continuous, as between the points, f(x)=0.

The method 100 can include translating the first visual data set into a continuous three-dimensional map (Step 106). The continuous three-dimensional map can include semantic information and geometric information. The first visual data set can include discrete data representing a three-dimensional environment that is translated into a continuous three-dimensional map by conversion of the discrete data into three-dimensional Gaussian ellipsoids. This can be done by replacing the delta functions of the discrete data of the first visual data set with a smooth spatial kernel, such as a Gaussian ellipsoid. The Gaussian ellipsoid can be defined by

$$N ( x \vert {μ}_{i} , {Σ}_{i} ) = exp [ - ( 1 / 2 ) ( x - {μ}_{i}^{T} {Σ}_{i}^{- 1} ( x - {μ}_{i} ) ) ] / [ ( 2 {π}^{3} ) \vert {Σ}_{i} \vert ] \hat{} ( 1 / 2 )$$

where μᵢ is the center of the Gaussian in three-dimensional space (based on the discrete sensor measurement location) and Σᵢ is a covariance matrix that defines the shape and spread. The exponential term decays smoothly with distance from the center.

The discrete points can now be replaced by defining

$$f ( x ) = {\sum }_{i = 1}^{n} ( {w}_{i} * N ( x \vert μ i , Σ i ) ) ,$$

where wᵢ is a weight that can encode color intensity, opacity, or some other semantic information. Thereby, each term x is defined in f(x) explicitly, even if x is not a measurement location. Further, the Gaussian is defined for all x in the three-dimensional space. Blending of the Gaussians can be achieved by summation, and the sum is continuous as the sum of continuous functions is inherently continuous. Further, there are no gaps in the map, as between any two discrete measurement points used as input, the Gaussian kernels overlap and fill the space.

In contrast, the three-dimensional representations of NeRFs and VLFMs lack this continuity. NeRFs attempt to represent three-dimensional continuity as a continuous volumetric field, which can be learned by a neural network. NeRFs take as input a discrete point or set of points in three-dimensional space and a view direction, and produce an output of color and density at each point within the three-dimensional space. This produces a radiance field within the three-dimensional space in which continuity is not explicit but learned implicitly. In order to render a three-dimensional scene, NeRFs use ray marching, querying hundreds of points per ray, each sampled discretely. Therefore, the map generated at any arbitrary point is a discrete representation based on finite sample points. Further undermining the continuity of NeRFs is that any view-dependent effects are inherently coupled to the underlying training views. Generalization to any views unseen in training tend to exhibit flickering or ghosting due to inadequate sampling density, inherent in the lack of continuity. Further, rendering NeRFs scenes can be relatively computationally expensive because each discrete ray must be processed individually. This makes real-time or interactive rendering challenging. While the NeRF three-dimensional map can use sampling and interpolation to simulate continuity in theory, the computational requirements in doing so can make any real-time or interactive rendering very challenging.

VLFMs attempt to relate three-dimensional geometry, two-dimensional (2D) imagery, and natural language into a latent embedding space, and thereby produce maps that, while abstract, are still discrete. VLFMs can generate three-dimensional content from text, encode point clouds or voxels into feature embeddings, and reconstruct a coarse three-dimensional structure from image-language pairs. They do so by producing one or more of point clouds, voxel grids, or latent fields, which require sampling and interpolation to represent three-dimensional objects. VLFMs abstract away geometry and texture into high-dimensional embeddings. VLFMs optimize for understanding and generation, not for consistent view synthesis or fine-grained geometry. While this allows them to generate plausible shapes, the resulting geometry is inherently discrete, and often coarse, noisy, or sparse. There is no assurance of spatial continuity between neighboring points or voxels. As such, the maps they produce are discrete, non-differentiable, and often unsuitable for high-quality, real-time rendering without additional post-processing.

The method 100 can include receiving instruction data (Step 104). The instruction data can include natural language passed to the system by one or more users via a user interface. Instruction data may be received by an instruction interpreting subsystem, which can process the instructions (such as “find all fruits in a room”) and convert the instructions into actionable tasks for the one or more robots. The instruction interpreting subsystem can be configured to translate the instructions into specific objectives that one or more robots may understand and execute, effectively linking natural language instructions with the geometric information and semantic understanding of the three-dimensional map to guide the actions of the one or more robots.

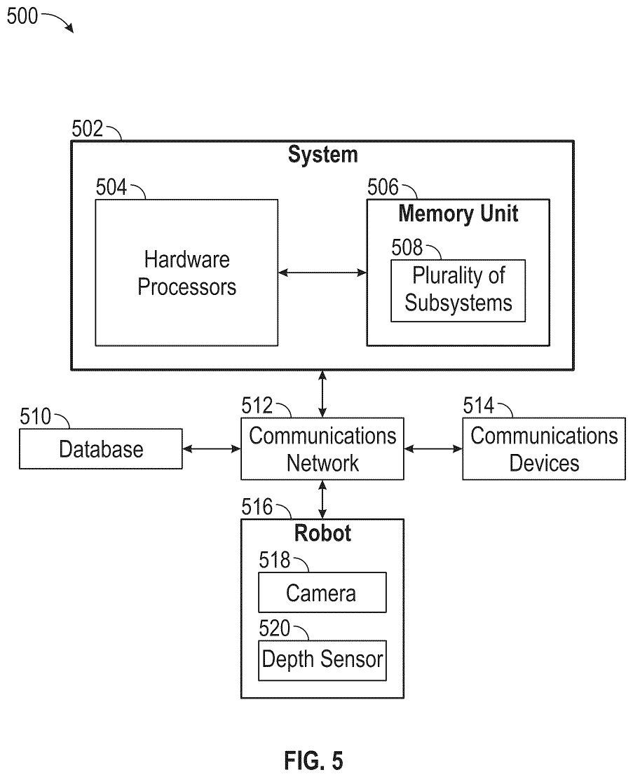

The method 100 can include converting the instruction data into at least one task (Step 108) for the robot within the continuous three-dimensional map. The converting step can include identifying target locations (waypoints) that the one or more robots must reach, using a navigation subsystem that plans efficient, obstacle-aware routes from a continuous three-dimensional map. This can include computation of a likelihood-of-success value via a value field, a scalar field over a three-dimensional space that assigns each point a score for navigation or manipulation, which can be based on cost, safety, risk, other semantic information, or a combination thereof. This value field can be derived from a smoothed, distilled semantic feature field and may encode distance to goals, semantic relevance, and risk, yielding high values near goals and low values near obstacles. Step 108 can include selecting a task that optimizes overall objectives, thereby balancing success likelihood with other priorities such as safety or cost. By way of example and without limitation, the method 100 can be performed by use of the environment, systems, and data flows explained with reference to FIGS. 5-9 in more detail below.

FIG. 2 is a flow diagram illustrating an example method for translating the first visual data set into a continuous three-dimensional map (Step 106). The translating can include generating an ellipsoid data set (Step 110). As described regarding FIG. 1, based on the obtaining of discrete data in the first visual data set, which can include visual odometry data and RGBD data, the discrete data can be converted to an ellipsoid cloud containing position and covariance data for each ellipsoid.

The ellipsoid data set can then be projected onto a two-dimensional plane (Step 112). As described regarding FIG. 1, this can include a summation of the ellipsoids generated based on the discrete data to generate a single, continuous three-dimensional map, and generating a local view by, for example, forward splatting, which can incorporate occlusion handling. Gaussians can be blended in front-to-back order based on depth, ensuring that nearer surfaces obscure further ones. This results in accurate depth perception within a two-dimensional plane, which can be a local map and can be beneficial for robotics, augmented reality, and scene editing. Due to the density and overlap of the ellipsoids, the entire three-dimensional space is defined in a continuous manner, and any two-dimensional projection, such as a camera view, can result in a smooth image due to the blending of the ellipsoids onto a two-dimensional plane. 3DGS thereby provides for continuous scene representation, as the representation itself is continuous. The overlapping Gaussian ellipsoids form a dense, smooth approximation of a scene that is inherently both continuous and lacking gaps in scene coverage, as objects have an explicit spatial extent. Further, 3DGS, by avoiding the need for ray marching, can be forward rendering and relatively computationally efficient. 3DGS is also advantageous in that it is differentiable, making it useful for manipulation such as relighting, segmentation, and augmented reality overlays, and in that its map is resolution independent, as there are no grid, voxel, or sample resolution constraints on the explicitly defined ellipsoids. In contrast, NeRFs require discretized sampling of a black-box function, and VLFMs produce spatially coarse outputs of discrete points. 3DGS thereby provides a dense, smooth, and explicit representation of three-dimensional scenes that inherently lends itself to continuous maps. The use of overlapping anisotropic Gaussians ensures both visual fidelity and spatial continuity, enabling high-quality renderings from arbitrary viewpoints. In contrast, NeRF-based methods, such as VLFMs, are constrained by sampling, resolution, and network generalization issues, and the maps produced by such methods are inherently discrete representations that lack geometric continuity and differentiability.

The projecting 112 can include color coding the semantic information and the geographic information (Step 114). Objects within the map can then be color coded based on semantic information or geometric information within the map. Color coding three-dimensional continuous map can include assigning each ellipsoid an artificial, class-specific color that is based on semantic or geometric labels rather than true appearance. Labels can come from manual annotation or post-segmentation using 2D/3D semantic segmentation. Based on classification of the ellipsoid due to its position or object type, a color can be mapped to that label. When rendered, the map shows smooth color blends and gradients that mirror the continuity of the underlying semantic feature field. Unlike point clouds, meshes, or neural fields that require separate labels/textures, 3DGS can encode semantic color within each ellipsoid for a unified, fast, and navigable 3D representation. As an example, the upper part of the visual representation may display a ceiling-like structure with intense pink and magenta hues, creating a sense of enclosure for the scene. Throughout the scene, there may be areas of color blending and gradient effects, which may represent the smooth and continuous nature of the semantic feature representation. The use of varied colors and intensities may indicate different semantic features or object classifications within the environment. Color coding can include specific colors (which can be artificial and not photorealistic) which are assigned to Gaussians based on the object or class to which they belong. This can be achieved by manual or post-segmentation labeling, where, after generating the Gaussian splats from real-world images or a scan, a separate segmentation model (e.g., a 2D or three-dimensional semantic segmentation neural network) is used to classify each Gaussian. Once a semantic label is assigned (like “chair”, “tree”, “car”), a unique color can be mapped to that label. This color does not necessarily represent real appearance but serves as a semantic identifier. Another method can be training for semantic appearance. As an example, the color field of each Gaussian can be learned not from actual RGB values, but from a semantic color space. For example, a red Gaussian might indicate “pedestrian”, green for “vegetation”, and blue for “sky.” When the scene is rendered using these semantic colors, the result is a color-coded three-dimensional map, visually indicating what each part of the scene represents. Unlike traditional point clouds or meshes that require separate labels or textures, the resulting continuous three-dimensional map carries ellipsoids with their own semantic color, enabling fast rendering of labeled scenes. By color coding, the visual representation provides the representation of both the geometric information and the semantic information in a single, coherent view.

3DGS with color coding can provide a unified representation of three-dimensional environments. Its explicit geometric structure captures spatial detail, while its flexible use of color allows semantic labels to be visually and functionally embedded. By combining these two layers—geometry and semantics—in the same framework, a continuous three-dimensional map generated by 3DGS is a platform for real-time three-dimensional understanding. 3DGS can provide a continuous, explicit representation of space that combines both geometric structure and semantic meaning. In contrast, NeRFs and VLFMs rely on discrete or latent representations, such as neural fields, point clouds, or voxel grids, where semantic information must be in a separate file.

The inclusion of both semantic information and geometric information within the same continuous three-dimensional map can provide several technical advantages over NeRFs and VLFMs in rendering quality, memory efficiency, editability, real-time interaction, and downstream task integration.

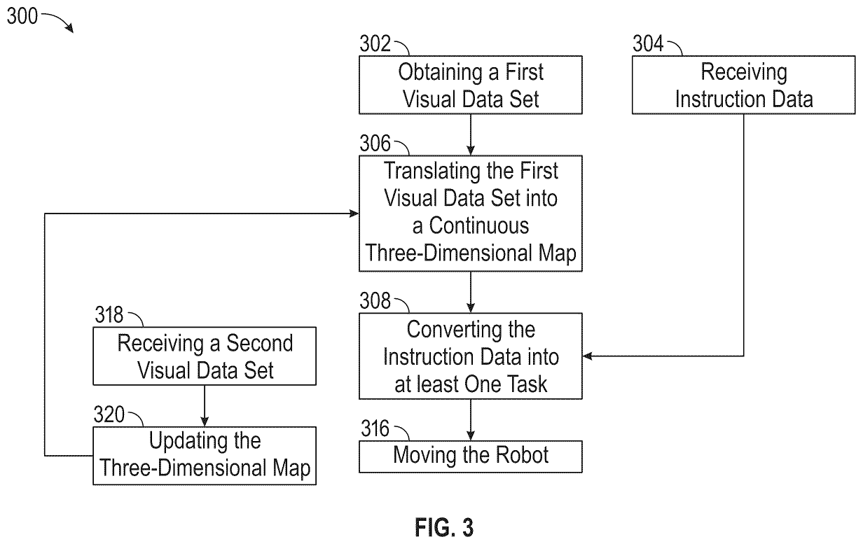

FIG. 3 is a flow diagram illustrating an example method 300 for robot navigation. Steps 302, 304, 306, and 308 can be identical to those described with regard to method 100 of FIG. 1, and for the sake of brevity, are not described further here.

The method 300 can include moving the robot (Step 316). Moving the robot can include guiding the movements of the one or more robots and interactions within its environment based on the three-dimensional map and the instructions. Utilizing the map and the instructions, specific waypoints, which can include targets and locations, can be identified that the robot must reach to accomplish its tasks. To identify specific locations or target, the robot may use a navigation subsystem configured to calculate efficient paths across the entire environment while considering obstacles and optimizing travel routes. The navigation subsystem can be configured to manage precise movements required for interacting with the objects in proximity, such as picking up items or navigating around small obstacles, and thereby perform manipulation of the local map. The navigation subsystem can ensure that the one or more robots navigate and perform tasks effectively, allowing the one or more robots to move seamlessly across the scene and handle the objects with accuracy and safety.

The method 300 can include receiving a second visual data set (Step 318). The second visual data set may include RGBD data and may be obtained by at least one camera and at least one depth sensor on the robot. The method 300 can utilize the data obtaining subsystem to obtain the second visual data set. This second visual data set can include discrete data like that of the first data set described in FIG. 1. This new data set can reveal new viewpoints and any scene changes, augmenting and correcting a distilled semantic feature field by providing updated evidence about geometry, semantics, lighting, and dynamic objects. The second visual data set can be used to detect drift, fill previously unknown regions, and validate or revise earlier classifications. The method can thereby re-estimate the value field, refresh waypoint candidates, and inform manipulation targets so downstream navigation can adapt to current conditions.

The method 300 can include updating the three-dimensional map (Step 320). The discrete data obtained at step 318 can be incorporated into the first visual data set and used to update the continuous three-dimensional map. This can be done, for example, by averaging the second visual data set with the first visual data set, addition of the second visual data set to the first visual data set, or some combination of averaging and addition, and by the generation of new continuous Gaussian ellipsoids which can be blended into a single, continuous three-dimensional map f(x) as explained in step 106. Step 320 can integrate the second visual data set into the existing map by registering new observations, adding new Gaussians, and refining means, covariances, and semantic colors of existing ellipsoids. Combination of the second visual data set with the first smooths the field and can reconcile inconsistencies to maintain a consistent global scene. The updated map thereby enables replanning: recomputing value fields, waypoints, and safe paths for navigation and manipulation. This update loop can yield a real-time, labeled 3D map that stays aligned with the scene.

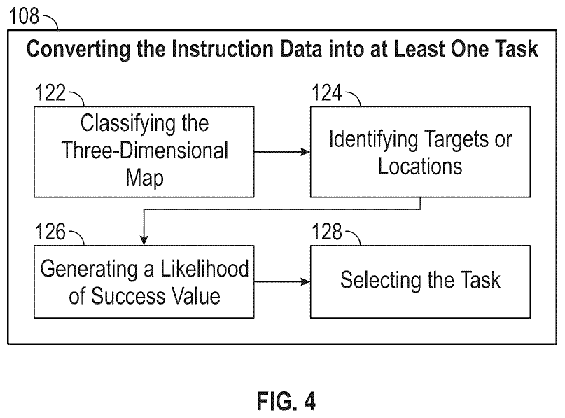

FIG. 4 is a flow diagram illustrating an example method for converting the instruction data into at least one task (Step 108). The converting method 108 can include classifying the three-dimensional map (Step 122). As described with regard to FIG. 8, this can be done by a classifying subsystem, which can use the smoothed map generated by the data processing subsystem. This smoothed map can include a mathematical representation of the inner and outer portions of surfaces in the scene, as in, for example, a Signed Distance Function (SDF). A SDF is a mathematical function used in computer graphics, robotics, and other fields to represent shapes and surfaces in a three-dimensional space, and can be represented where values within objects are negative, and values outside of objects are positive. Thereby, an SDF or similar function can provide a shortest distance from any point in the space to surface of a shape within a local or global scene and Step 122 can use the function to distinguish between navigable and non-navigable spaces within the scene, effectively outlining where the robot may and may not go. This can include assigning semantic labels and scalar values to scene elements by combining geometric information with language-conditioned semantics to segment Gaussians into classes, such as, for example, floor, ceiling, doorway, table, or graspable object. Scalar values can be assigned based on traversability, reachability, and safety margins, which can be generated to form a surface/semantic map with topological connectivity.

The converting method 108 can include identifying target locations (Step 124). This can be done by determining specific locations or targets (waypoints) the one or more robots need to reach to accomplish their tasks. Using the instruction data (e.g., “pick up the blue mug”), the method can correlate a request with the classified map and propose candidate goal regions and intermediate waypoints based on completion of the goal. It builds a cost-aware graph over the global scene to find feasible, obstacle-aware routes that respect kinematic limits for the robot. By the value field, waypoints can be annotated with utility, reachability, and any required manipulation context. The result is a prioritized set of targets and provisional paths for evaluation. This can be done by using a navigation subsystem, which, based on the output of a classifying subsystem that generates the surface map, can calculate efficient paths across the entire global scene while considering obstacles and optimizing travel routes.

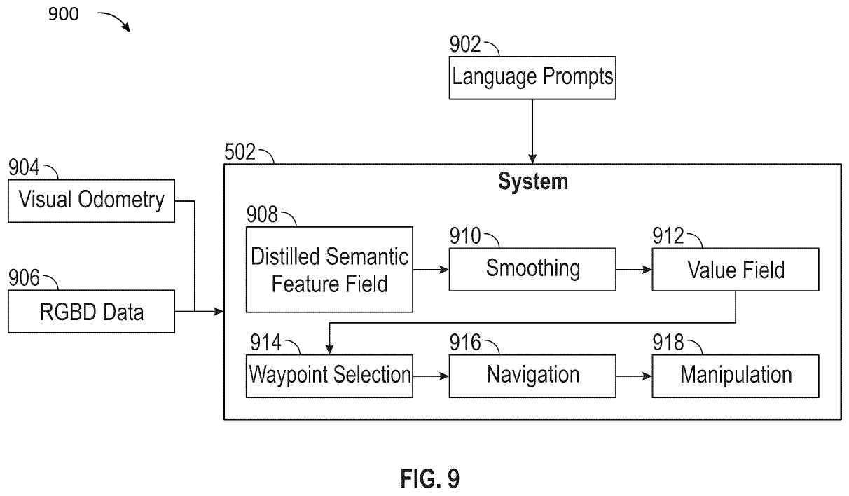

The converting method 108 can include generating a likelihood of success value (Step 126). As shown regarding FIG. 9, this too can be done by use of the value field, which can provide information about where a robot is to go based on task objectives, and thereby by generating a likelihood of success value for task completion. The value field, being constructed over the map to quantify utility, risk, semantic match, and cost for navigation/manipulation for each space, can be applied to each candidate target or path. The value field can encode distance to a goal, semantic relevance, or safety, based on semantic information of objects within the scene. Values can further be, for example, high values near goals and low values near obstacles or poor semantic match. For each candidate target/path, the system can aggregate values in the field to produce a likelihood-of-success metric. These scores guide which options are most promising given task objectives.

The converting method 108 can include selecting a task (Step 128). Based on the likelihood of success value generated at step 126, a task can be selected to optimize for one or more goals based on the values encoded in the value field and the generated likelihood of success value. Comparison of candidate tasks—navigation only, navigation plus manipulation, or information-gathering, can be performed via a multi-objective score that weights success likelihood, safety, and cost per the instruction. Selection of the task with an optimal score thereby includes an executable plan with that can include waypoints, control modes, and manipulation substeps. In some embodiments, as new observations arrive, scores can be regenerated, and the plan can be replanned to maintain optimality. Thereby, the task selection can be based both on likelihood of success of task completion and other goals, such as safety or cost. The outputs can include the chosen task and expected success probability dispatched to the robot.

FIG. 5 depicts an example environment 500 in which a system 502 of the present embodiments may operate. The environment 500 can include a system 502, database 510, communications network 512, communications devices 514, and robot 516. The system 502 can include hardware processors 504 and a memory unit 506. The memory unit 506 can include a plurality of subsystems 508. The robot 516 can include at least one camera 518 and at least one depth sensor 520.

The one or more hardware processors 504, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 504 may also include embedded controllers, such as generic or programmable logic devices or arrays, application-specific integrated circuits, single-chip computers, and the like.

The environment 500 can include a system 502 that includes the memory unit 506. The memory unit 506 may be the non-transitory volatile memory and the non-volatile memory. The memory unit 506 may be coupled to communicate with the one or more hardware processors 504, such as being a computer-readable storage medium. The one or more hardware processors 504 may execute machine-readable instructions and/or source code stored in the memory unit 506. A variety of machine-readable instructions may be stored in and accessed from the memory unit 506. The memory unit 506 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 506 can include the plurality of subsystems 508.

The environment 500 can include a plurality of subsystems 508. The plurality of subsystems 508 can be stored in the form of machine-readable instructions on any of the above-mentioned storage media and may be in communication with and executed by the one or more hardware processors 504. A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also include programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

The environment 500 can include a database 510. The database 510 may include, but not limited to, storing, and managing data related to visual odometry data and RGBD data, which visual odometry data and RGBD data were previously obtained via at least one camera and at least one depth sensor. The database 510 can serve as a central repository for all relevant data, enabling efficient data retrieval and analysis to support decision-making processes. The database 510 can include semantic information for inclusion within the continuous three-dimensional map, and thereby facilitates the semantic-based robotic navigation in scene. Furthermore, the database 510 may manage user access controls, configuration settings, and system logs, providing a comprehensive solution for data management and security within the network architecture.

The environment 500 can include a communications network 512. Communications network 512 can include one or more communications networks 512 and can be, but not limited to, a wired communication network, a wireless communication network, or a combination of wired communication networks and wireless communications networks. The wired communication network may include, but not be limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may include, but not be limited to, at least one of: wireless fidelity (wi-fi), cellular networks (including 4G (fourth generation), 5G (fifth generation), and 6G (sixth generation) networks), Bluetooth, ZigBee, long-range wide area network (LoRaWAN), satellite communication, radio frequency identification (RFID), advanced IoT protocols, mesh networks, non-terrestrial networks (NTNs), near field communication (NFC), and the like. The one or more communication networks 512 can be configured to facilitate data exchange and communication between the system 502 and the database 510 for real-time data analysis.

The environment 500 can include communications devices 514. The communications devices 514 can be one or more communication devices 514 and may represent various network endpoints, such as, but not limited to, user devices, mobile devices, smartphones, Personal Digital Assistants (PDAs), tablet computers, phablet computers, wearable computing devices, Virtual Reality/Augmented Reality (VR/AR) devices, laptops, desktops, display interface panels, control panels, human machine interface panels, liquid crystal display (LCD) screens, light-emitting diode (LED) screens, and the like. The one or more communication devices 514 can be configured to function as an intermediate unit between the system 502 and one or more users. The one or more communication devices 514 can be equipped with a user interface that allows the one or more users to interact with the system 502. The user interface may include graphical displays, touchscreens, voice recognition, and other input/output mechanisms that facilitate easy access to data and control functions. Any other instructions may be provided by the one or more users to the system 502 via the user interface.

The environment 500 can include a robot 516, which can be one or more robots 516. The robots can be one or more robots 516 and may be, but not restricted to, at least one of a: quadruped, wheeled robot, biped, drone, and the like. The robot 516 can communicate with the system 502, communications devices 514, and database 510 via the communications network 512.

The robot 516 can include at least one camera 518 and at least one depth sensor 520. The camera 518 and depth sensor 520 are configured to track the movement of the one or more robots 516, assisting the one or more robots 516 in understanding its position and orientation within the complex scene. The camera 518 can be one or more RGB cameras and the depth sensor 520, which can be one or more depth sensors, are configured to capture both color information and depth data, which indicates how far away objects are in the environment.

Those of ordinary skilled in the art will appreciate that the hardware depicted in FIG. 5 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 502 as is unique to the present disclosure or necessary for an understanding of the present disclosure is depicted and described. The remainder of the construction and operation of the system 502 may conform to any of the various current implementations and practices that were known in the art.

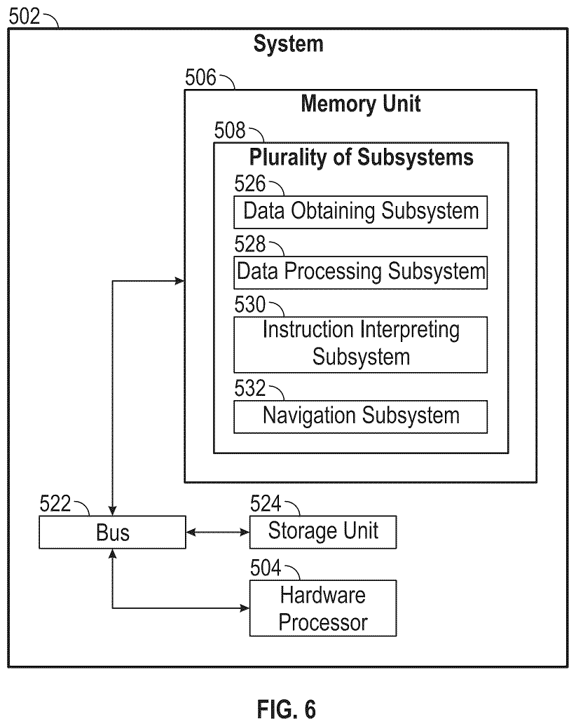

FIG. 6 is a block diagram showing an example system 502 of the present embodiments along with its corresponding subsystems. The system 502 can include a memory unit 506, bus 522, storage unit 524, and hardware processor 504. The memory unit 506 can include a plurality of subsystems 508, which can include a data obtaining subsystem 526, data processing subsystem 528, instruction interpreting subsystem 530, and navigation subsystem 506.

The system 502 can include a memory unit 506. The memory unit 506 may be the non-transitory volatile memory and the non-volatile memory. The memory unit 506 may be coupled to communicate with the one or more hardware processors 504, such as being a computer-readable storage medium. The one or more hardware processors 504 may execute machine-readable instructions and/or source code stored in the memory unit 506. A variety of machine-readable instructions may be stored in and accessed from the memory unit 506. The memory unit 506 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 506 can include includes the plurality of subsystems 508.

The system 502 can include a bus 522. The system bus 504 can function as a central conduit for data transfer and communication between the one or more hardware processors 504, the memory unit 506, and the storage unit 524. The system bus 522 facilitates the efficient exchange of information and instructions, enabling a coordinated operation of the system 502. The system bus 522 may be implemented using various technologies, including, but not limited to, parallel buses, serial buses, or high-speed data transfer interfaces such as, but not limited to, at least one of a: universal serial bus (USB), peripheral component interconnect express (PCIe), and similar standards.

The system can include a storage unit 524. The storage unit 524 may be a cloud storage or the database 510, such as those shown in FIG. 5. The storage unit 524 may store, but not limited to, recommended course of action sequences dynamically generated by the system 502. These action sequences can include data-obtaining, data processing, instruction interpreting, robot navigation, and the like. The storage unit 524 may be any kind of database such as, but not limited to, relational databases, dedicated databases, dynamic databases, monetized databases, scalable databases, cloud databases, distributed databases, any other databases, graph databases, vector databases, and a combination thereof.

The plurality of subsystems 508 can include a data obtaining subsystem 526. The data-obtaining subsystem 526 is configured to obtain visual odometry data from cameras and the RGBD data from RGB cameras and depth sensors. The cameras are configured to track the movement of one or more robots, assisting the one or more robots in understanding its position and orientation within the scene. The RGB cameras and the depth sensors are configured to capture both color information and depth data, which indicates how far away objects are in the environment. The data-obtaining subsystem 526 is configured to gather comprehensive visual information and depth data about the surroundings, and can store the information as discrete data that includes visual odometry data and RGBD data, which can be a second visual data set.

The plurality of subsystems 508 can include a data processing subsystem 528. In an exemplary embodiment, the data-processing subsystem 528 is configured with a 3DGS procedure, as described above with regard to FIG. 1 and FIG. 2. The 3DGS procedure is employed to create a smooth, continuous 3D representation of the environment by blending data points, which assists in rendering a realistic and coherent 3D map. The data-processing subsystem 528 is configured to analyze the visual information to identify and label different objects and features within the environment, such as fruits, furniture, and the like. The data-processing subsystem 528 is configured to process visual information and the depth data into the 3D map that includes both geometric information, which can include such information as shape, size, position, distance, and the like, and semantic information, such as identifying what the objects are. The data-processing subsystem 528 is configured to provide a refined and clear representation of the scene, ensuring that each object's identity and location are accurately defined, thereby enhancing the ability of one or more robots to understand and interact with its surroundings.

The data-processing subsystem 528 can be configured to generate a smoothed 3D map. This smoothed map can include a mathematical representation of the inner and outer portions of surfaces in the scene, as in, for example, an SDF. The SDF can provide a shortest distance from any point in the space to a surface of a shape within a local or global scene. By utilizing this map, the classifying subsystem can use the smoothed map to distinguish between navigable and non-navigable spaces within the scene, effectively outlining where the one or more robot may and may not go.

The plurality of subsystems 508 can include an instruction interpreting subsystem 530. The instruction interpreting subsystem 530 can receive language prompts from a user, and based on the language prompts, convert the instructions into at least one task for the robot. The instruction interpreting subsystem 530 can process the instructions given by one or more users (such as “find all fruits in a room”) and convert the instructions into actionable tasks. The instruction interpreting subsystem 530 can be configured to translate the instructions into specific objectives that one or more robots may understand and execute, effectively linking natural language instructions with the visual information and semantic understanding to guide the actions of the one or more robots.

The plurality of subsystems 508 can include a navigation subsystem 532. The navigation subsystem 514 can be configured to guide the movements of the one or more robots and interactions within the scene based on the 3D map and the instructions. The navigation subsystem 532 can be configured to identify specific locations or targets (waypoints) the one or more robots need to reach to accomplish its tasks. The navigation subsystem 532 can be configured to calculate efficient paths across the entire environment while considering obstacles and optimizing travel routes by using the continuous three-dimensional map. Using the continuous three-dimensional map, the navigation subsystem 532 can be configured to manage precise movements required for interacting with the objects in close proximity, such as picking up items or navigating around small obstacles, thereby manipulating the local scene. Thereby, the navigation subsystem 532 can be configured to ensure that one or more robots navigate and perform tasks effectively, allowing one or more robots to move seamlessly across the room and handle the objects with accuracy and safety.

Though few components and a plurality of subsystems 508 are disclosed in FIG. 6, there may be additional components and subsystems which is not shown, such as, but not limited to, ports, routers, repeaters, firewall devices, network devices, the database 510, network attached storage devices, assets, machinery, instruments, facility equipment, emergency management devices, image capturing devices, any other devices, and combination thereof. The person skilled in the art should not be limiting the components/subsystems shown in FIG. 6. Although FIG. 6 illustrates the system 502, and the one or more communication devices 514 connected to the database 510, one skilled in the art can envision that the system 502, and the one or more communication devices 514 may be connected to several user devices located at various locations and several databases via the one or more communication network 512.

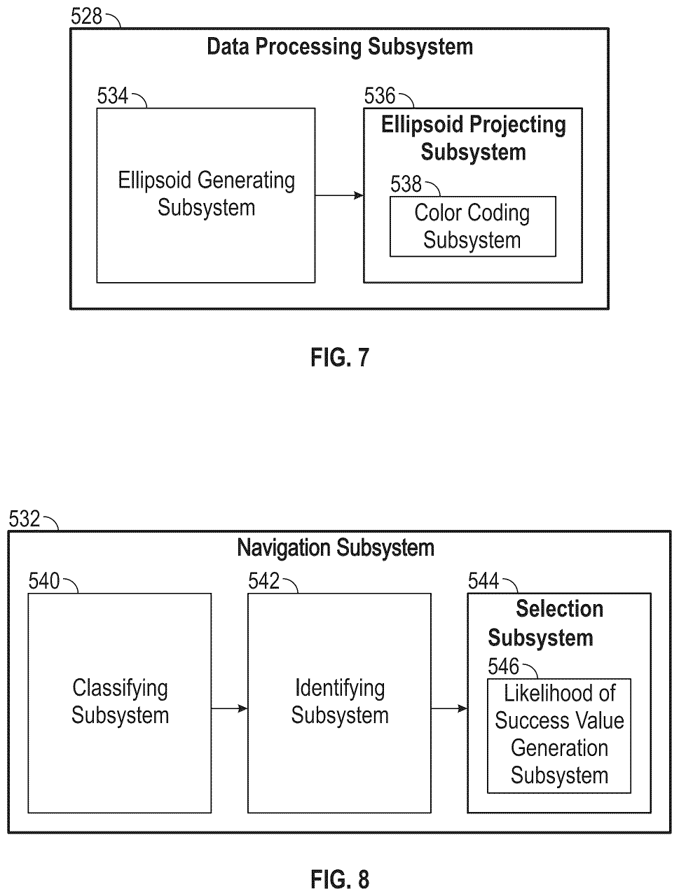

FIG. 7 is a block diagram showing an example data processing subsystem 528 of the system shown in FIG. 6. The data processing subsystem 528 can include an ellipsoid generating subsystem 534 and an ellipsoid projecting subsystem 536.

The ellipsoid generating subsystem 534 can translate the first visual data set by generating an ellipsoid data set including a plurality of ellipsoids based on the first visual data set. Each ellipsoid in the ellipsoid data set can include position data and covariance data. The ellipsoid generating subsystem can convert discrete point cloud data from visual odometry and RGBD data into continuous Gaussian ellipsoids. As described with regard to FIG. 1, this can be done by taking as input the first visual data set, which can consist of discrete data that includes RGBD data and visual odometry data from sensor measurements. This data can be expressed as a sum of Dirac delta functions, replacing the Dirac delta functions with a smooth spatial kernel, such as a Gaussian ellipsoid.

The ellipsoid projecting subsystem 536 can utilize the Gaussian ellipsoid to replace the original, discretely-define map with a continuous three-dimensional map by blending the Gaussian ellipsoids into a single, continuous function. Thereby, each point x within the map is defined explicitly, even if x is not a measurement location in the underlying discrete data. The Gaussian is defined for all x in the three-dimensional space. Blending of the Gaussians can be achieved by summation, and the sum is continuous as the sum of continuous functions is inherently continuous. Further, there are no gaps in the map, as between any two discrete measurement points used as input, the Gaussian kernels overlap and fill the space. These objects can be projected and blended in an image space using a forward rendering pipeline, as opposed to the ray-marching techniques of NeRFs. Therefore, each Gaussian object can blur into nearby space, and is not a hard, discrete point, but a smooth function in three-dimensional space that can overlap with neighboring objects, thereby generating a continuous volumetric field constructed from discrete elements. Summation of the ellipsoids generated based on the discrete data can generate a single, continuous three-dimensional map projected onto a two-dimensional plane. This can also incorporate forward splatting. which can include occlusion handling. Gaussians can be blended in front-to-back order based on depth, ensuring that nearer surfaces obscure further ones. This results in accurate depth perception within a two-dimensional plane. Due to the density and overlap of the ellipsoids, the entire three-dimensional space is defined in a continuous manner, and any two-dimensional projection, such as a camera view, can result in a smooth image due to the blending of the ellipsoids onto a two dimensional plane.

Moreover, because Gaussians are differentiable, it is possible to train them end-to-end with multi-task objectives: optimizing for both appearance reconstruction and semantic labeling, using both photometric and categorical source information. A truly continuous three-dimensional representation, such as a dense cloud of anisotropic Gaussians produced by 3DGS, can provide resolution independence. Each point in space can be sampled at arbitrary precision without being confined to a voxel grid or fixed sample intervals. This means that rendering is smooth across all view angles and distances. Further, there are no jagged edges or artifacts caused by voxel resolution limits, and fine geometric detail is preserved without needing massive memory for each point in space. In contrast, NeRFs must discretize space during ray marching, and are inherently limited in resolution by the underlying point cloud. VLFMs that use voxel grids or point clouds are inherently resolution-bound, and increasing detail requires exponential memory growth.

The ellipsoid projecting subsystem can include a color coding subsystem 538. which can assign specific colors (often artificial, not photorealistic) to Gaussians based on the object or class they belong to which the Gaussian belongs. The object or class they to which they belong can be based on geometric information, semantic information, or a combination of semantic information and geometric information. This can be achieved by manual or post-segmentation labeling, where, after generating the Gaussian splats from real-world images or a scan, a separate segmentation model (e.g., a 2D or three-dimensional semantic segmentation neural network) is used to classify each Gaussian. Once a semantic label is assigned (like “chair”, “tree”, “car”), a unique color can be mapped to that label. This color does not necessarily represent real appearance but serves as a semantic identifier.

FIG. 8 is a block diagram showing an example navigation subsystem of the system shown in FIG. 6. The navigation subsystem 532 can include a classifying subsystem 540. The classifying subsystem 540 can classify the continuous three-dimensional map into navigable and non-navigable spaces for the robot based on receipt of a smoothed three-dimensional map received from the data-processing subsystem. This smoothed map can include a mathematical representation of the inner and outer portions of surfaces in the scene, as in, for example, a Signed Distance Function (SDF). The SDF can provide a shortest distance from any point in the space to surface of a shape within a local or global scene. Thereby, the classifying subsystem 540 can use the smoothed map to distinguish between navigable and non-navigable spaces within the scene, effectively outlining where the one or more robots may and may not go.

The navigation subsystem can include an identifying subsystem 542. The identifying subsystem 542 can, based on the output of the classifying subsystem 540, identify waypoints based on a value field (as explained in FIG. 9). Based on the continuous three-dimensional map being classified into spaces where the robot can and cannot go, the identifying subsystem can construct possible paths for completion of the at least one task within the map. The possible paths can include overlap between them, which thereby identifying targets or locations within the three-dimensional map that the robot must reach to complete the at least one task.

The navigation subsystem 532 can include a selection subsystem 544. The selection subsystem 544 can be configured to select a task for at least one robot based on the instructions and a generated likelihood of success value. The selection subsystem can include a likelihood of success value generation subsystem 546 to generate this likelihood of success value. By use of a value field based on a distilled semantic feature field and smoothed map, which can provide information about where a robot is to go based on task objectives, the likelihood of success value generation subsystem 546 can generate a likelihood of success value for task completion associated with a particular path. The value field can be a scalar field defined across the three-dimensional space, where each point has a value representing the utility, cost, desirability, risk, etc. for navigation or manipulation. The value field can encode distance to a goal, semantic relevance, or safety, based on semantic information of objects within the scene. The value field can be derived from a smoothed distilled semantic feature field, but is defined by task objectives, generating a navigation and manipulation map with, for example, high values near goals, low values near obstacles or risks. Based on the likelihood of success value, and the selection subsystem 544 can identify a set of tasks selected to optimize for one or more goals based on the values encoded in the value field and the generated likelihood of success value. Thereby, the task selection can be optimized based both on likelihood of successful task completion and other goals, such as safety or cost.

FIG. 9 depicts an example data flow 900 to and within the system of the present embodiments. The data flow 900 can include the system receiving a first data set, which can include visual odometry data 904 and RGBD data 906. This can be performed by a data obtaining subsystem. The data obtaining subsystem can obtain visual odometry data 904 and RGBD data from a database, where that data was previously obtained via at least one camera and at least one depth sensor, and can obtain the data directly from at least one camera and at least one depth sensor.

The system 502 can also receive language prompts 902 via an instruction interpreting subsystem, which can be received via an interface. The instruction interpreting subsystem can be configured to process the instructions given by the one or more users and convert the instructions into actionable tasks for the one or more robots. The instruction interpreting subsystem can be configured to translate the instructions into specific objectives that the one or more robots may understand and execute, effectively linking natural language instructions with the visual information and semantic understanding to guide the actions of the one or more robots.

The system 502 can utilize the first visual data set to generate a distilled semantic feature field 908, which can be done via a data processing subsystem Via 3DGS as described regarding FIG. 1 and FIG. 2, the data processing subsystem can build a continuous three-dimensional map. To generate the distilled semantic feature field 908, the three-dimensional map can be augmented with semantic information, which can be obtained from the database. This can be the process of assigning semantic information to each Gaussian in a scene, thereby converting a purely visual model into one that can support understanding and be queried based on semantic concepts, and not purely geometric. The semantic features can be transferred from a vision-language model, such as a vision transformer, into a model that can operate directly on 3DGS objects. Each Gaussian can be augmented with a feature vector representing semantic attributes, and thereby the features are assigned directly to the Gaussians, providing the representation with both semantic and geometric information. Generation of the distilled semantic feature field 908 can thereby attach semantic information to each part of the continuous, three-dimensional map.

The distilled semantic feature field 908 can then undergo smoothing 910 to provide a smooth, coherent three-dimensional value map 912. This can convert the Gaussian map into a continuous three-dimensional scalar field representing distance to the nearest surface. By way of example, this can be done by utilizing the semantic and geographic information within the distilled semantic feature field 908 to define surfaces of objects within the map. For example, values representing spaces inside of objects can be negative, and values outside of objects can be positive, thereby, a zero-crossing indicates an object boundary or surface. This can provide for smooth transition between Gaussians, accurate obstacle detection in navigation, and scene completion, where gaps between Gaussians are defined within the map. This can provide a continuous, three-dimensional map with a space defining where a navigating object, such as a robot, can and cannot go. The smoothing 910 can utilize semantic information in the generation of the value field 912. Thereby, the value field 912 can provide information about where to go based on task objectives and be utilized to generate a likelihood of success value for task completion. The value field 912 can be a scalar field defined across the three-dimensional space, where each point has a value representing the utility, cost, desirability, risk, etc. for navigation or manipulation. The value field 912 can encode distance to a goal, semantic relevance, or safety, based on semantic information of objects within the scene. The value field 912 can be derived from the distilled semantic feature field 908, but is defined by task objectives, generating a map for navigation and manipulation with, for example, high values near goals, low values near obstacles or risks.

The value field 912, being integrated into a continuous three-dimensional map, can include geometry and semantics coexist within the same data structure. Each Gaussian encodes not only three-dimensional position and shape, via covariance, but also can include color, opacity, and potentially semantic labels through color coding or auxiliary attributes. This unified model can support photorealistic rendering, where the scene looks realistic from any view, semantic mapping, where objects are labeled and distinguished, by, for example, color coding, and scene understanding, where spatial relationships between semantic entities (e.g., “a cup on a table”) can be directly queried. In contrast, NeRFs and VLFMs often separate geometry and semantics. NeRFs focus on photometric reconstruction, and semantic labels-if available-must be inferred post hoc. VLFMs can encode semantic meaning but can lack high-fidelity geometric structure without substantially increased memory costs, limiting their usefulness for precise spatial tasks.

Based on the value field 912, the system 502 can perform waypoint selection 914 within the continuous three-dimensional map. Waypoint selection 914 can include the identification and selection of intermediate steps towards completion of the at least one task, and can be performed by a navigation subsystem. Based on the value field, the system 502 can select intermediate target points that will guide the robot towards task completion. Waypoint selection 914 can be chosen based on the value field 912, and optimized for safety, such as avoiding collisions based on geometric information or avoiding risky areas based on semantic information (such as traveling a space that may include high heat or relying on objects with low structural integrity). Waypoint selection 914 can be chosen based on the value field 912 and optimized for efficiency, such as movement through high-value regions. Waypoint selection 914 can be chosen based on the value field 912 and optimized for goal completion, such as a combination of safety and efficiency.

Based on the waypoint selection 914, the system 502 can perform navigation 916. In the process of navigation 916, the system 502 can plan and move along a path utilizing the entire continuous, three-dimensional map of the scene. The system 502 can reason over the entire scene, including areas unseen within the current projection, to plan an optimal route based on the waypoint selection 914. Navigation 916 can include making global path planning decisions and performed based on the entire distilled semantic feature field 908 that has been smoothed 910 and with waypoints selected 914 based on the value field 912.

Based on the navigation 916, the system 502 can direct manipulation 918 of the local map. Manipulation 918 can be granular, task-specific control in the local vicinity of the robot or target object within the continuous three-dimensional map. Manipulation 918 can include such tasks as picking up an object, pressing a button, or avoiding clutter or other possible obstructions by utilizing semantic information and geometric information within the robot's immediate surroundings. While the navigation 916 can identify where the robot will go, manipulation 918 can identify what the robot is to do at intermediate steps or at task completion, thereby enabling interaction with the scene.

Continuous three-dimensional maps built with Gaussians can be rendered in real time on GPUs. The forward rendering pipeline avoids computationally costly ray marching and neural inference, making it ideal for interactive applications like augmented reality overlays, virtual walkthroughs, live scene editing, and robotic navigation. In contrast, NeRFs and VLFMs typically require multiple seconds per frame unless heavily optimized or pre-baked into alternate formats (which introduces latency or artifacts). Further, 3DGS avoids the need for large neural networks and inference-heavy pipelines. The parameters of each Gaussian are compact and interpretable, and thereby the rendering process is GPU-accelerated and parallelizable. In contrast, NeRFs rely on multilayer perception with millions of parameters and require constant evaluation during ray marching. VLFMs operate in large embedding spaces and often depend on transformer backbones with high compute costs and large memory footprints-making them unsuitable for edge devices or interactive environments.

Because each Gaussian has explicit parameters (position, size, shape, etc.), 3DGS can produce continuous three-dimensional maps are directly editable, users can move, remove, or recolor individual objects, add semantic labels or overlays, and apply region-specific effects or filters, greatly aiding the navigation 916 throughout the entire scene and manipulation 918 of the local scene. In contrast, NeRFs or VLFMs have scenes encoded in a neural network, where changing a single object can require retraining the entire field. Further, continuous maps can interpolate across sparse data more effectively. The overlapping nature of Gaussians means that even with partially missing regions, nearby splats can still produce visually plausible outputs that are continuous. Their soft spatial extent acts as a natural prior for smoothing 910.

A continuous three-dimensional map that integrates both geometric information and semantic information in a single map, as enabled by in 3DGS, offers compelling technical advantages over discrete alternatives like NeRFs and VLFMs. It enables high-resolution, editable, and semantically aware three-dimensional representation.

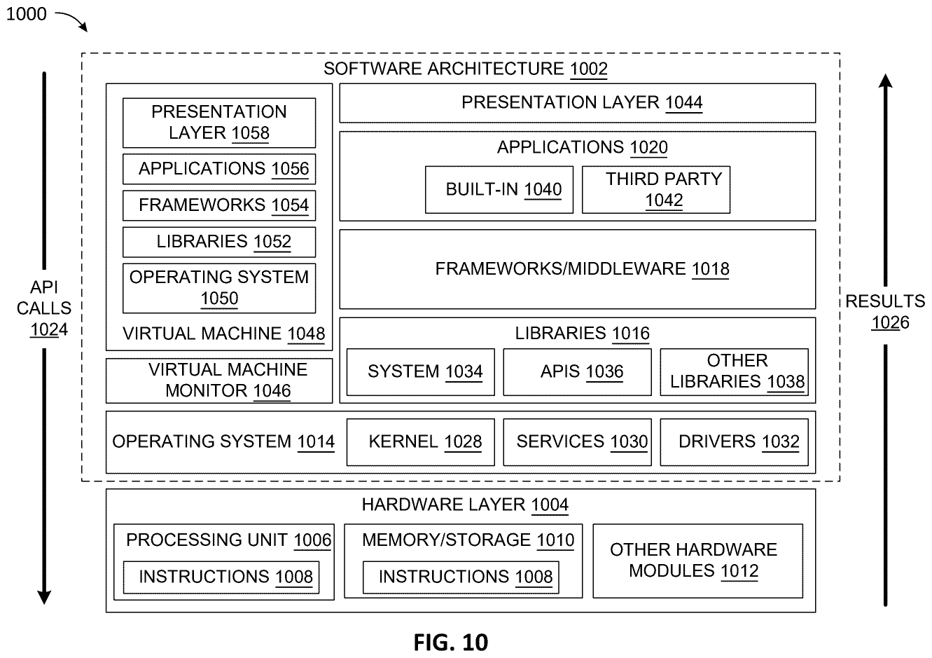

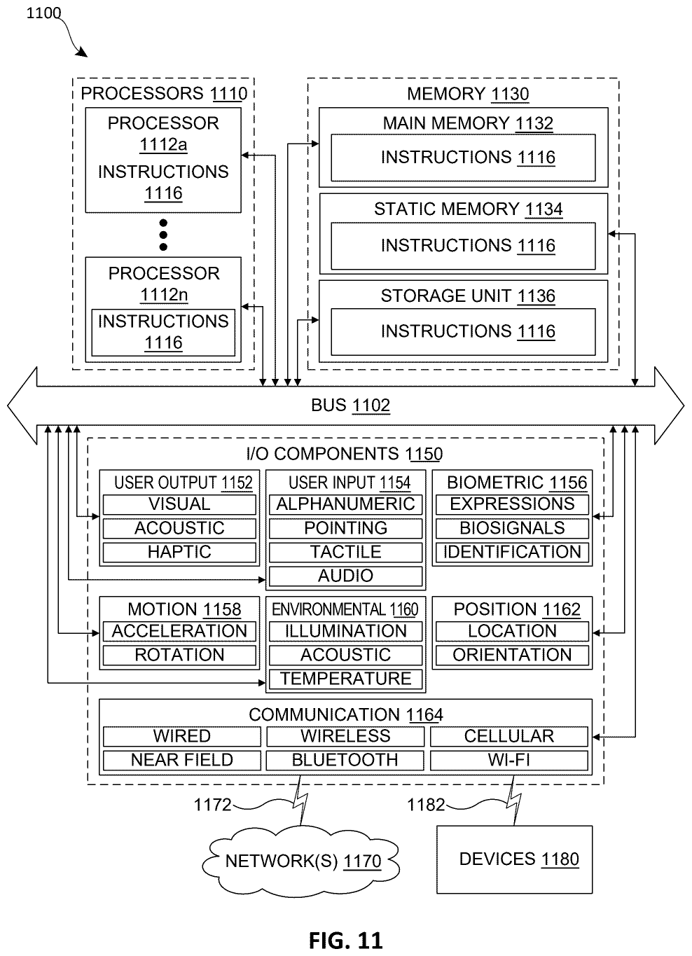

FIG. 10 is a block diagram 1000 illustrating an example software architecture 1002, various portions of which may be used in conjunction with various hardware architectures herein described, which may implement any of the above-described features. FIG. 10 is a non-limiting example of a software architecture, and it will be appreciated that many other architectures may be implemented to facilitate the functionality described herein. The software architecture 1002 may execute on hardware such as a machine 1100 of FIG. 11 that includes, among other things, processors 1110, memory/storage, and input/output (I/O) components 1150. A representative hardware layer 1004 is illustrated and can represent, for example, the machine 1100 of FIG. 11. The representative hardware layer 1004 includes a processing unit 1006 and associated executable instructions 1008. The executable instructions 1008 represent executable instructions of the software architecture 1002, including implementation of the methods, modules and so forth described herein. The hardware layer 1004 also includes a memory/storage 1010, which also includes the executable instructions 1008 and accompanying data. The hardware layer 1004 may also include other hardware modules 1012. Instructions 1008 held by processing unit 1006 may be portions of instructions 1008 held by the memory/storage 1010.

The example software architecture 1002 may be conceptualized as layers, each providing various functionality. For example, the software architecture 1002 may include layers and components such as an operating system (OS) 1014, libraries 1016, frameworks/middleware 1018, applications 1020, and a presentation layer 1044. Operationally, the applications 1020 and/or other components within the layers may invoke API calls 1024 to other layers and receive corresponding results 1026. The layers illustrated are representative in nature and other software architectures may include additional or different layers. For example, some mobile or special purpose operating systems may not provide the frameworks/middleware 1018.

The OS 1014 may manage hardware resources and provide common services. The OS 1014 may include, for example, a kernel 1028, services 1030, and drivers 1032. The kernel 1028 may act as an abstraction layer between the hardware layer 1004 and other software layers. For example, the kernel 1028 may be responsible for memory management, processor management (for example, scheduling), component management, networking, security settings, and so on. The services 1030 may provide other common services for the other software layers. The drivers 1032 may be responsible for controlling or interfacing with the underlying hardware layer 1004. For instance, the drivers 1032 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1016 may provide a common infrastructure that may be used by the applications 1020 and/or other components and/or layers. The libraries 1016 typically provide functionality for use by other software modules to perform tasks, rather than interacting directly with the OS 1014. The libraries 1016 may include system libraries 1034 (for example, C standard library) that may provide functions such as memory allocation, string manipulation, file operations. In addition, the libraries 1016 may include API libraries 1036 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1016 may also include a wide variety of other libraries 1038 to provide many functions for applications 1020 and other software modules.

The frameworks/middleware 1018 provide a higher-level common infrastructure that may be used by the applications 1020 and/or other software modules. For example, the frameworks/middleware 1018 may provide various graphic user interface (GUI) functions, high-level resource management, or high-level location services. The frameworks/middleware 1018 may provide a broad spectrum of other APIs for applications 1020 and/or other software modules.

The applications 1020 include built-in applications 1040 and/or third-party applications 1042. Examples of built-in applications 1040 may include, but are not limited to, a contacts application, a browser application, a location application, a media application, a messaging application, and/or a game application. Third-party applications 1042 may include any applications developed by an entity other than the vendor of the particular platform. The applications 1020 may use functions available via OS 1014, libraries 1016, frameworks/middleware 1018, and presentation layer 1044 to create user interfaces to interact with users.

Some software architectures use virtual machines, as illustrated by a virtual machine 1048. The virtual machine 1048 provides an execution environment where applications/modules can execute as if they were executing on a hardware machine (such as the machine 1100 of FIG. 11, for example). The virtual machine 1048 may be hosted by a host OS (for example, OS 1014) or hypervisor, and may have a virtual machine monitor 1046 which manages operation of the virtual machine 1048 and interoperation with the host operating system. A software architecture, which may be different from software architecture 1002 outside of the virtual machine, executes within the virtual machine 1048 such as an OS 1050, libraries 1052, frameworks 1054, applications 1056, and/or a presentation layer 1058.

FIG. 11 is a block diagram illustrating components of an example machine 1100 configured to read instructions from a machine-readable medium (for example, a machine-readable storage medium) and perform any of the features described herein. The example machine 1100 is in a form of a computer system, within which instructions 1116 (for example, in the form of software components) for causing the machine 1100 to perform any of the features described herein may be executed. As such, the instructions 1116 may be used to implement modules or components described herein. The instructions 1116 cause unprogrammed and/or unconfigured machine 1100 to operate as a particular machine configured to carry out the described features. The machine 1100 may be configured to operate as a standalone device or may be coupled (for example, networked) to other machines. In a networked deployment, the machine 1100 may operate in the capacity of a server machine or a client machine in a server-client network environment, or as a node in a peer-to-peer or distributed network environment. Machine 1100 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1100 is illustrated, the term “machine” includes a collection of machines that individually or jointly execute the instructions 1116.

The machine 1100 may include processors 1110, memory/storage 1130, and I/O components 1150, which may be communicatively coupled via, for example, a bus 1102. The bus 1102 may include multiple buses coupling various elements of machine 1100 via various bus technologies and protocols. In an example, the processors 1110 (including, for example, a central processing unit (CPU), a graphics processing unit (GPU), a digital signal processor (DSP), an ASIC, or a suitable combination thereof) may include one or more processors 1112a to 1112n that may execute the instructions 1116 and process data. In some examples, one or more processors 1110 may execute instructions provided or identified by one or more other processors 1110. The term “processor” includes a multicore processor including cores that may execute instructions contemporaneously. Although FIG. 11 shows multiple processors, the machine 1100 may include a single processor with a single core, a single processor with multiple cores (for example, a multicore processor), multiple processors each with a single core, multiple processors each with multiple cores, or any combination thereof. In some examples, the machine 1100 may include multiple processors distributed among multiple machines.

The memory/storage 1130 may include a main memory 1132, a static memory 1134, or other memory, and a storage unit 1136, both accessible to the processors 1110 such as via the bus 1102. The storage unit 1136 and memory 1132, 1134 store instructions 1116 embodying any one or more of the functions described herein. The memory/storage 1130 may also store temporary, intermediate, and/or long-term data for processors 1110. The instructions 1116 may also reside, completely or partially, within the memory 1132, 1134, within the storage unit 1136, within at least one of the processors 1110 (for example, within a command buffer or cache memory), within memory at least one of I/O components 1150, or any suitable combination thereof, during execution thereof. Accordingly, the memory 1132, 1134, the storage unit 1136, memory in processors 1110, and memory in I/O components 1150 are examples of machine-readable media.

As used herein, “machine-readable medium” refers to a device able to temporarily or permanently store instructions and data that cause machine 1100 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1116) for execution by a machine 1100 such that the instructions, when executed by one or more processors 1110 of the machine 1100, cause the machine 1100 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1150 may include a wide variety of hardware components adapted to receive input, provide output, produce output, transmit information, exchange information, capture measurements, and so on. The specific I/O components 1150 included in a particular machine will depend on the type and/or function of the machine. For example, mobile devices such as mobile phones may include a touch input device, whereas a headless server or IoT device may not include such a touch input device. The particular examples of I/O components illustrated in FIG. 11 are in no way limiting, and other types of components may be included in machine 1100. The grouping of I/O components 1150 are merely for simplifying this discussion, and the grouping is in no way limiting. In various examples, the I/O components 1150 may include user output components 1152 and user input components 1154. User output components 1152 may include, for example, display components for displaying information (for example, a liquid crystal display (LCD) or a projector), acoustic components (for example, speakers), haptic components (for example, a vibratory motor or force-feedback device), and/or other signal generators. User input components 1154 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1150 may include biometric components 1156, motion components 1158, environmental components 1160, and/or position components 1162, among a wide array of other physical sensor components. The biometric components 1156 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1158 may include, for example, acceleration sensors (for example, an accelerometer) and rotation sensors (for example, a gyroscope). The environmental components 1160 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1162 may include, for example, location sensors (for example, a Global Position System (GPS) receiver), altitude sensors (for example, an air pressure sensor from which altitude may be derived), and/or orientation sensors (for example, magnetometers).

The I/O components 1150 may include communication components 1164, implementing a wide variety of technologies operable to couple the machine 1100 to network(s) 1170 and/or device(s) 1180 via respective communicative couplings 1172 and 1182. The communication components 1164 may include one or more network interface components or other suitable devices to interface with the network(s) 1170. The communication components 1164 may include, for example, components adapted to provide wired communication, wireless communication, cellular communication, Near Field Communication (NFC), Bluetooth communication, Wi-Fi, and/or communication via other modalities. The device(s) 1180 may include other machines or various peripheral devices (for example, coupled via USB).

In some examples, the communication components 1164 may detect identifiers or include components adapted to detect identifiers. For example, the communication components 1164 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1164, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A method of navigation for a robot, comprising:
obtaining, by at least one camera and at least one depth sensor, a first visual data set;
translating the first visual data set into a continuous three-dimensional map, wherein the continuous three-dimensional map comprises semantic information and geometric information;
receiving instruction data; and
converting the instruction data into at least one task for the robot within the continuous three-dimensional map.

2. The method of claim 1, wherein the first visual data set comprises visual odometry data and red-green-blue-depth data.

3. The method of claim 1, wherein translating the first visual data set includes generating, based on the first visual data set, an ellipsoid data set comprising a plurality of ellipsoids, wherein each ellipsoid in the ellipsoid data set comprises position data and covariance data.

4. The method of claim 3, wherein translating the first visual data set includes projecting the ellipsoid data set onto a two-dimensional plane.

5. The method of claim 4, wherein projecting the ellipsoid data set onto a two-dimensional plane includes color coding the semantic information and the geometric information into the three-dimensional map.

6. The method of claim 1, wherein converting the instruction data includes classifying the continuous three-dimensional map into navigable and non-navigable spaces for the robot.

7. The method of claim 1, wherein the converting includes identifying targets or locations within the three-dimensional map that the robot must reach to complete the at least one task.

8. The method of claim 1, wherein the at least one task is selected based on a likelihood of success value.

9. The method of claim 1, further comprising:
moving the robot to perform the at least one task;
receiving, by the at least one camera or at least one depth sensor, a second visual data set; and
updating the three-dimensional map by incorporating the second visual data set into the first visual data set.

10. A system comprising:
a processor; and
a memory in communication with the processor, the memory comprising executable instructions that, when executed by the processor, cause the system to perform functions of:
obtaining, by at least one camera and at least one depth sensor, a first visual data set;
translating the first visual data set into a continuous three-dimensional map, wherein the continuous three-dimensional map comprises semantic information and geometric information;
receiving instruction data; and
converting the instruction data into at least one task for a robot within the continuous three-dimensional map.

11. The system of claim 10, wherein the first visual data set comprises visual odometry data and red-green-blue-depth data.

12. The system of claim 10, wherein to translate the first visual data set, the memory further includes executable instruction that, when executed by the processor, cause the system to perform a function of generating, based on the first visual data set, an ellipsoid data set including a plurality of ellipsoids, wherein each ellipsoid in the ellipsoid data set comprises position data and covariance data.

13. The system of claim 12, wherein to translate the first visual data set, the memory further includes executable instruction that, when executed by the processor, cause the system to perform a function of projecting the ellipsoid data set onto a two-dimensional plane.

14. The system of claim 13, wherein to project the ellipsoid data set onto the two-dimensional plane, the memory further includes executable instruction that, when executed by the processor, cause the system to perform a function of color coding the semantic information and the geometric information into the three-dimensional map.

15. The system of claim 10, wherein to convert the instruction data, the memory further includes executable instruction that, when executed by the processor, cause the system to perform a function of classifying the continuous three-dimensional map into navigable and non-navigable spaces for the robot.

16. The system of claim 10, wherein the to convert the instruction data, the memory includes executable instruction that, when executed by the processor, cause the system to perform a function of identifying targets or locations within the three-dimensional map that the robot must reach to complete the at least one task.

17. The system of claim 10, wherein the at least one task is selected based on a likelihood of success value.

18. The system of claim 10, wherein the memory further comprises executable instructions that, when executed by the processor, cause the system to perform functions of:
moving the robot to perform the at least one task;
receiving, by the at least one camera or at least one depth sensor, a second visual data set; and
updating the three-dimensional map by incorporating the second visual data set into the first visual data set.

19. A non-transitory computer readable medium on which are stored instructions that when executed cause a programmable device to:
obtain, by at least one camera and at least one depth sensor, a first visual data set;
translate the first visual data set into a continuous three-dimensional map, wherein the continuous three-dimensional map comprises semantic information and geometric information;
receive instruction data; and
convert the instruction data into at least one task for a robot within the continuous three-dimensional map.

20. The non-transitory computer readable medium of claim 19, wherein the instructions when executed further cause the programmable device to:
move the robot to perform the at least one task;
receive, by the at least one camera or at least one depth sensor, a second visual data set; and
update the three-dimensional map by incorporating the second visual data set into the first visual data set.
